(19) United States
(12) Patent Application Publication
(10) Pub. No.: US 2016/0115071 A1
(43) Pub. Date: Apr. 28, 2016

(54) DEVICE AND METHOD FOR MANUFACTURING INORGANIC FIBERS BY INTERNAL CENTRIFUGAL SPINNING

(71) Applicant: SAINT-GOBAIN ISOVER, Courbevoie (FR)

(72) Inventors: Julien THIERY, Paris (FR); Kenichiro TERAGAMI, Kasumigaura-city (JP); Amaud MARCHAL, Nancy (FR)

(73) Assignee: SAINT-GOBAIN ISOVER, Courbevoie (FR)

(21) Appl. No.: 14/889,465

(22) PCT Filed: May 6, 2014
(86) PCT No.: PCT/FR14/51063

§ 371 Date: Nov. 6, 2015

(30) Foreign Application Priority Data
May 7, 2013 (FR) 13 54156

(51) Int. Cl. C03B 37/04; C03B 37/10

(52) U.S. Cl. CPC C03B 37/04; C03B 37/10

(57) ABSTRACT

A device for manufacturing inorganic fibers by internal centrifugal spinning including: a centrifugal spinner configured to form inorganic fibers by fiberizing from molten inorganic material and at least one ring configured to spray water onto the inorganic fibers being formed. The device makes it possible to manufacture dry inorganic fibers thereby making energy savings.

The invention relates to a device and a method for manufacturing inorganic fibers by internal centrifugal spinning in order in particular to manufacture inorganic fibers suited to vacuum insulation panels (VIPs).

Vacuum insulation panels are, for example, panels made of inorganic fibers, which have been compressed and kept under vacuum.

The inorganic fibers intended for vacuum insulation panels need to be stripped of binder in order to avoid degassing after manufacture as such degassing would prevent the vacuum from being maintained. However, it is necessary to moisten the fibers in order to cool the atmosphere in the receiving area during fiberizing and thus make fume extraction easier, or alternatively to lubricate the fibers. The adhesive coating ring can be used to convey water onto the fibers. Water is then sprayed onto the fibers already formed, before they are received on the fiber receiving mat. Fibers fall, wet, onto the receiving mat.

In order to achieve the vacuum correctly it is advantageous for the inorganic fibers to be as dry as possible. As a result, after they have been collected on the receiving mat, they are passed through at least one oven in order to dry them before they can be used in a vacuum insulation panel. However, passing through an oven represents a high energy cost.

There is therefore a need for a device and a method for manufacturing inorganic fibers that allow dry inorganic fibers to be manufactured, thereby making energy savings.

For that reason, the invention proposes a device for manufacturing inorganic fibers by internal centrifugal spinning, comprising:
a centrifugal spinner designed to form inorganic fibers by fiberizing from molten inorganic material,
at least one ring designed to spray water onto the inorganic fibers being formed.

According to another particular feature, a ring is positioned between 150 and 300 mm below the centrifugal spinner and/or a ring is positioned just above the centrifugal spinner.

According to another particular feature, the angle at which the ring positioned under the centrifugal spinner sprays water is comprised between −45° and +45° with respect to the horizontal, preferably between −30° and +30°.

According to another particular feature, the angle at which the ring positioned above the centrifugal spinner sprays water is vertical or inclined by an angle less than or equal to 20° with respect to the vertical toward the axis of symmetry of the centrifugal spinner.

According to another particular feature, the total quantity of water sprayed is comprised between 5 l/h and 400 l/h, preferably between 100 l/h and 250 l/h. According to another particular feature, the total quantity of water sprayed is comprised between 5 and 550 l per metric tonne of glass.

According to another particular feature, the quantity of water sprayed by the ring positioned above the centrifugal spinner is comprised between 0% and 80% of the total quantity of water, and the quantity of water sprayed by the ring positioned under the centrifugal spinner is comprised between 20% and 100% of the total quantity of water.

According to another particular feature, the ring positioned above the centrifugal spinner is designed to blow compressed air at the same time as spraying water.

According to another particular feature, the water sprayed is atomized water.

The invention also relates to a method for manufacturing inorganic fibers by centrifugal spinning using the device described hereinabove, comprising the following steps:
using a centrifugal spinner to form inorganic fibers from molten inorganic material,
using a ring to spray water onto the inorganic fibers being formed.

The invention also relates to a method for manufacturing vacuum insulation panels, comprising the following steps:
the method for manufacturing inorganic fibers described hereinabove,
bagging the inorganic fibers obtained, preferably under a primary vacuum, or even under a secondary vacuum, preferably with the insertion of a desiccant.

The invention also relates to a product obtained using the method described hereinabove, containing a moisture content of below 0.1% after manufacture, without passing through an oven.

According to another particular feature, the product has a penetration force of between 500 and 800 N.

According to another particular feature, the product is packaged in fluid-tight packaging, the packaging containing a desiccant in a quantity of preferably less than 1 g per kg of product.

Other features and advantages of the invention will now be described with reference to the drawings in which:
The FIGURE depicts a view in cross-section of the device for manufacturing inorganic fibers according to the invention.

Throughout the patent application, the terms “above” and “below” are defined with reference to the fiberizing position when the centrifugal spinner is in the fiberizing position, i.e. when the axis of rotation of the centrifugal spinner is along a vertical axis.

In addition, throughout the description, the expression “comprised between . . . and . . . ” includes the end points.

The invention relates to a device for the manufacture of inorganic fibers by centrifugal spinning, comprising an internal centrifugal spinning device designed to form inorganic fibers from molten inorganic material and at least one ring designed to spray water, preferably atomized water, onto the inorganic fibers being fiberized, as they are being formed.

Thus, water is sprayed onto the inorganic fibers as they are being formed, i.e. while the fibers are being drawn, then once they have been drawn, for as long as they remain incompletely solidified. Because the atmosphere around the fibers being formed is very hot, the water evaporates almost immediately, making it possible to obtain dry fibers on the fiber receiving mat.

In addition, the fact of spraying water onto the fibers as they are being formed gives them hydrophobic properties, making it possible to avoid the need to use an oven when the fibers are used following their manufacture. If necessary, desiccants may be used during storage to avoid an uptake of moisture. However, because the fibers have hydrophobic properties, the amount of desiccant required is minimal.

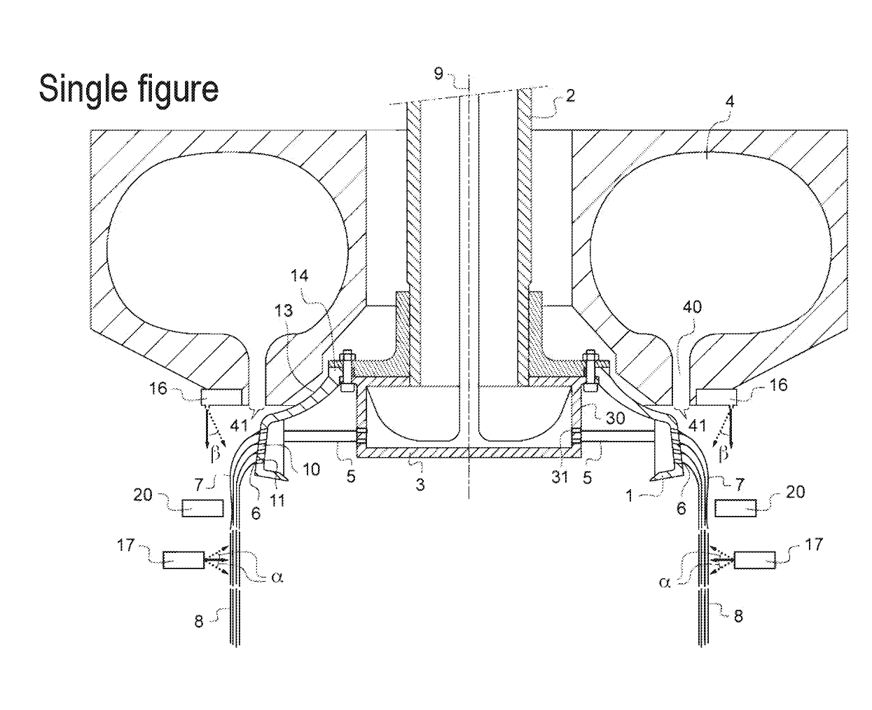

FIG. 1 depicts a device for manufacturing inorganic fibers according to the invention.

The device comprises a centrifugal spinner 1, also referred to as a fiberizing dish, comprising an annular wall 10 pierced with a plurality of orifices 11. The annular wall 10 extends, to form the top of the centrifugal spinner 1, in the form of a web 13 ending in a bell 14.

The device also comprises a hollow shaft 2 of axis 9, suited to being rotationally driven by a motor (not depicted). The centrifugal spinner 1 is fixed to the shaft 2 via the bell 14. When the device for forming inorganic fibers is in the fiberizing position, the axis 9 is vertical. At its upper end, the shaft 2 is connected to molten glass feed means. At its lower end, the shaft 2 is connected either to a basket 3 if the centrifugal spinner is bottomless, or directly to the centrifugal spinner 1 in the case of a centrifugal spinner that has a bottom. In the case of a device with a basket, as indicated in the FIGURE, the basket 3 is situated inside the centrifugal spinner 1. The basket 3 comprises an annular wall 30 pierced with a plurality of orifices 31.

When the device for forming inorganic fibers is in operation, the centrifugal spinner 1, the shaft 2 and possibly the basket 3 are rotationally driven about the axis 9 of the shaft 2. Molten glass flows into the shaft 2, from the molten glass feed means as far as the centrifugal spinner, in which the molten glass spreads out. In the case of a centrifugal spinner with a basket, the molten glass flows as far as the basket 3 and is then thrown onto the annular wall 30 of the basket, passes through the plurality of orifices 31 of the basket and, in the form of voluminous filaments 5, is thrown against the peripheral wall 10 of the centrifugal spinner 1. A permanent reserve of molten glass therefore forms in the centrifugal spinner to feed the plurality of orifices 11 pierced in the annular wall 10 of the centrifugal spinner 1. Molten glass passes through the plurality of orifices 11 of the centrifugal spinner 1 to form overrun cones 6 which extend as pre-fibers 7.

The device for forming inorganic fibers also comprises at least one annular burner 4 generating a high-temperature gaseous drawing jet. The gaseous drawing jet is a high-temperature gaseous stream which emanates from the annular burner 4 via the outlet 40 thereof provided with lips 41, so that the gaseous drawing jet is more or less tangential to the annular wall 10 of the centrifugal spinner 1. In the fiberizing position, the outlet 40 of the annular burner 4 is situated above the annular wall 10 of the centrifugal spinner 1. The gaseous drawing jet is able both to heat the annular wall 10 of the centrifugal spinner 1 and the fibers that are in the process of being formed as they leave the centrifugal spinner 1. Under the action of the gaseous drawing jet of the annular burner the pre-fibers 7 are drawn, the terminal portion thereof generating discontinuous fibers 8 which are then collected on a receiving mat (not depicted) under the centrifugal spinner 1. No binder is used to create the product according to the invention; the device for forming inorganic fibers comprises no adhesive-coating device, and in particular no adhesive coating ring.

The device for forming inorganic fibers also comprises at least one ring 16, 17 which sprays water, preferably atomized water, onto the fibers as they are being formed. The fibers being formed are the fibers which have not fully solidified. A ring 16 is positioned just above the centrifugal spinner and/or a ring 17 is positioned under the centrifugal spinner. Each ring 16, 17 is substantially horizontal and has a plurality of atomized-water outlet orifices.

The orifices of the ring 16 positioned just above the centrifugal spinner 1 are directed downward and arranged at the same height as the lips 41 via which the gasses leave the burner 4. The water atomized by the ring 16 is sprayed vertically or with an inclination toward the axis 9 of the centrifugal spinner. The angle β of spraying is comprised between 0° and +20° with respect to the vertical. The layout of the ring 16 and the orientation of the jet of atomized water are such that the atomized water is sprayed onto the fibers in the process of being formed, i.e. the discontinuous fibers 8 that have not yet solidified.

The orifices of the ring 17 that is positioned under the centrifugal spinner 1 are oriented more or less horizontally. The ring 17 is positioned in such a way that its orifices are situated at a distance of between 100 and 300 mm away from the bottom of the centrifugal spinner 1, preferably at a distance of between 150 and 300 mm from the bottom of the centrifugal spinner 1, or at a distance alternatively comprised between 350 and 500 mm from the lips 41 of the burner 4. The angle α at which the atomized water is sprayed by the ring 17 is comprised between −45° and +45° with respect to the horizontal, and preferably of between −30° and +30°, and more preferably still of between 0° and +45°, or even between 0° and +30°, namely preferably horizontally or upwards. The ring 17 and the angle α of spraying of its orifices are such that the atomized water is sprayed onto the fibers in the process of being formed, namely onto the discontinuous fibers 8 that have not yet fully solidified.

The total quantity of water is comprised between 5 l/h and 400 l/h, preferably between 100 l/h and 250 l/h. Stated differently, the total quantity of sprayed water is preferably comprised between 5 and 550 l of water per metric tonne of glass. The quantity of water sprayed by the ring 16 positioned above the centrifugal spinner device is comprised between 0% and 80% of the total quantity of water and the quantity of water sprayed by the ring 17 positioned under the centrifugal spinner device is comprised between 20% and 100% of the total quantity of water.

The temperature at the ring 16 positioned above the centrifugal spinner 1 is of the order of the temperature of the gasses leaving the burner at the lips, namely in the region of 1400° C. for example. The temperature at the ring 17 is comprised between 650° C. and 1100° C. The atmosphere in which the water is sprayed is thus very hot, which means that the water evaporates almost instantaneously upon contact with the fibers in the process of being formed, which are themselves very hot. The fibers then arrive on the receiving mat dry, i.e. with a moisture content of less than 0.1%. By contrast, in an installation according to the prior art, water is sprayed onto the fibers that have already been formed in an atmosphere that is saturated with moisture in which the temperature is around 200° C. The fibers therefore arrive on the receiving mat wet. The device according to the invention makes it possible to manufacture a dry product which avoids the use of an oven and therefore allows energy savings to be made.

Spraying or vaporizing atomized water in an extremely hot atmosphere makes it possible to create water vapor, and this cools the atmosphere and makes it easier for the fibers to be sucked toward the receiving mat and also improves the distribution of the fibers on the receiving mat.

In addition, spraying or vaporizing atomized water on extremely hot fibers in the process of being formed, which are therefore not yet solidified, at least on the inside, means that the fibers are tempered. That improves the mechanical properties of the fibers, particularly the stamping property. That makes it possible, for the same density, to improve the ability of the vacuum insulation panels to withstand the vacuum pulling process. It also makes it possible to improve the thermal conductivity of the vacuum insulation panel.

The stamping property is measured according to the following procedure: 4 g of fibers are rolled into a cigar shape and introduced into a cylindrical cell. A rod is then introduced into the cylindrical cell and compresses the fibers. The penetration force of the fibers is then measured in Newton. The penetration force of the products obtained using the method according to the invention is comprised between 500 and 800 N.

The moisture content is measured using the following procedure: three test specimens with a cross-sectional surface area of 305 mm×305 mm are prepared. Each test specimen is weighed and its initial mass Pᵢₙᵢ noted. The test specimens are passed through an oven at 180° C. for 30 min then through a dryer for 1 hour. Each test specimen is weighed once again and its final mass P_{fin} noted. For each test specimen, the moisture content is equal to: (Pᵢₙᵢ−P_{fin})/P_{fin}.

For preference, the ring 16 positioned above the centrifugal spinner 1 is able in addition to spraying water to blow compressed air. Blowing compressed air makes it possible to prevent fibers from dispersing too far from the axis 9 of rotation of the centrifugal spinner 1.

The device for forming inorganic fibers also comprises, as an option, an induction ring 20 under the centrifugal spinner and/or an internal burner for heating the lowermost region of the centrifugal spinner and preventing or limiting the creation of a temperature gradient at the top of the centrifugal spinner.

The invention also relates to a method of manufacturing inorganic fibers by centrifugal spinning using the device as described hereinabove, involving the following steps:
using a centrifugal spinner device to form inorganic fibers from molten inorganic material,
spraying water onto the inorganic fibers being formed.

Following manufacture, the inorganic fibers are, for example, bagged, preferably under a primary vacuum or even under a secondary vacuum, if necessary with the insertion of a desiccant into the packaging, preferably in a quantity of less than 1 g per kg of product.

The product obtained using the method according to the invention contains under 0.1% moisture after manufacture, without passing through an oven.

An example of a product was produced using the device according to the invention under the following conditions:
a tonnage of 10 metric tonnes per day,
a temperature of 1400° C. for the gasses leaving the burner at the lips 41,
a burner pressure of 400 mmH₂O (water column),
a water flow rate of 70 l/h for the ring 17 positioned 150 mm under the centrifugal spinner, the ring 17 being in an atmosphere at a temperature of 700° C.,
a water flow rate of 130 l/h for the ring 16 positioned just above the centrifugal spinner, level with the lips of the burner.

The product obtained has a moisture content of 0.05% and a penetration force of 650 N.

By comparison, a standard product obtained under fiberizing conditions which are similar but without the spraying of water just above the centrifugal spinner and with water being sprayed 320 mm below the centrifugal spinner, at a position situated below the fiber drawing and formation zone, in an atmosphere with a temperature of 200° C. in which the glass fiber can no longer be deformed or drawn, at a flow rate of 350 l/h, has a moisture content of 0.35% and a penetration force of 400 N.

The product according to the invention is therefore indeed a dry product, which is not the case with the products produced in the standard way, and has enhanced mechanical properties.

1-14. (canceled)

15. A device for manufacturing inorganic fibers by internal centrifugal spinning, comprising:
a centrifugal spinner configured to form inorganic fibers by fiberizing from molten inorganic material; and
at least one ring configured to spray water onto the inorganic fibers being formed.

16. The device as claimed in claim 15, wherein a ring is positioned between 150 and 300 mm below the centrifugal spinner and/or a ring is positioned just above the centrifugal spinner.

17. The device as claimed in claim 16, wherein an angle at which the ring positioned under the centrifugal spinner sprays water is between −45° and +45° with respect to the horizontal.

18. The device as claimed in claim 16, wherein an angle at which the ring positioned under the centrifugal spinner sprays water is between −30° and +30° with respect to the horizontal.

19. The device as claimed in claim 15, wherein the angle at which the ring positioned above the centrifugal spinner sprays water is vertical or inclined by an angle less than or equal to 20° with respect to the vertical toward the axis of symmetry of the centrifugal spinner.

20. The device as claimed in claim 16, wherein a total quantity of water sprayed is between 5 l/h and 400 l/h.

21. The device as claimed in claim 16, wherein a total quantity of water sprayed is between 100 l/h and 250 l/h.

22. The device as claimed in claim 16, wherein a total quantity of water sprayed is between 5 and 550 l per metric ton of glass.

23. The device as claimed in claim 22, wherein the quantity of water sprayed by the ring positioned above the centrifugal spinner is between 0% and 80% of the total quantity of water, and the quantity of water sprayed by the ring positioned under the centrifugal spinner is between 20% and 100% of the total quantity of water.

24. The device as claimed in claim 16, wherein the ring positioned above the centrifugal spinner is configured to blow compressed air at a same time as spraying water.

25. The device as claimed in claim 16, wherein the water sprayed is atomized water.

26. A method for manufacturing inorganic fibers by internal centrifugal spinning using the device as claimed in claim 15, comprising:
using a centrifugal spinner to form inorganic fibers from molten inorganic material;
using a ring to spray water onto the inorganic fibers being formed.

27. A method for manufacturing vacuum insulation panels, comprising:
the method for manufacturing inorganic fibers as claimed in claim 26,
bagging the inorganic fibers obtained, under a primary vacuum.

28. A method for manufacturing vacuum insulation panels, comprising:
the method for manufacturing inorganic fibers as claimed in claim 26,
bagging the inorganic fibers obtained, under a primary vacuum, with insertion of a desiccant.

29. A product obtained using the method as claimed in claim 26, containing a moisture content of below 0.1% after manufacture, without passing through an oven.

30. The product as claimed in claim 29, having a penetration force of between 500 and 800 N.

31. The product as claimed in claim 29, packaged in fluid-tight packaging, the packaging containing a desiccant in a quantity of less than 1 g per kg of product.
